(19) United States
(12) Patent Application Publication
(10) Pub. No.: US 2024/0102559 A1
(43) Pub. Date: Mar. 28, 2024

(54) PRESSURE REGULATOR WITH FINE CONTROL

(71) Applicant: Woon's Medical Inc., Seongnam-si (KR)

(72) Inventor: Woon BAEK, Seongnam-si (KR)

(21) Appl. No.: 18/227,372

(22) Filed: Jul. 28, 2023

(30) Foreign Application Priority Data
Sep. 28, 2022 (KR) 10-2022-0123392

(51) Int. Cl. F16K 5/04

(52) U.S. Cl. CPC F16K 5/0407; F16K 5/0414; F16K 5/0442; F16K 31/041

(57) ABSTRACT

The invention relates to a pressure regulator with fine control, which has a simple structure and prevents the pressure of a fluid from rotating a stem to thereby improve reliability of a product. The fluid flowing into an inlet port of a housing flows out through an outlet port of the housing or is blocked according to the rotation angle of the stem.

### BACKGROUND OF THE INVENTION

### 1. Field of the Invention

The present invention relates to a pressure regulator with fine control and, more particularly, to a pressure regulator with fine control, which has a simple structure and prevents the pressure of a fluid from rotating a stem to thereby improve reliability of a product.

### 2. Description of the Related Art

In general, it is frequently necessary to supply a fluid to patients using, for example, catheters in medical fields. Such a catheter is equipped with valves to control or shut off the flow, pressure, direction, etc. of a drug. In addition, various valves for controlling the flow rate, direction, pressure, etc. of the fluid that flows in pipes are provided in industrial sites.

In general, valves function to selectively open or close fluid passages or prevent overpressure and include, for example, check valves, three-way valves, butterfly valves, ball valves, tube valves, etc.

Such a valve requires reliable and repeated operation to smoothly move or shut off fluid and may cause a serious accident if the valve does not operate properly during use. To this end, the valve has to be formed in a structure as simple as possible, and the valve should be designed with a small number of operating components. In a complex structure with a large number of components, any one of the components may operate improperly. This may increase the probability of failure.

However, valves according to the related art tend to have a large number of components and a complicated shape because the valves are too focused on smooth movement of fluid or accurate shutoff of fluid. This deteriorates the reliability of the product, and the complicated shape increases the manufacturing costs of products.

Also, related art 1 in Korean Patent Publication No. 10-2018-0109314 for a valve discloses a butterfly valve in which the coupling force between a rotation shaft and a valve disc is increased.

In related art 1, the fluid pressure is applied to the valve disc so as to increase the coupling force to the rotation shaft. Accordingly, the valve is configured to increase structural restraint coupling force between the valve disc and the rotation shaft by using a device for restraining the rotation shaft of the valve disc inside a valve body.

Also, related art 2 in Korean Patent No. 10-0665350 discloses a spool rotation-type direction switching valve. Related art 2 includes a case having a connection port formed thereon and a spool rotatably installed in the case. In related art 2, a fluid passage of the spool is formed outside the spool, and thus, a force to rotate the spool is generated while the fluid flows.

In addition, in the related arts, it is difficult to accurately check whether the valve is open or closed from the outside. Therefore, when a manager who manages the valve is confused about the valve state, serious results may occur.

### RELATED ART DOCUMENT

### Patent Documents

(Patent document 0001) Korean Application Publication No. 10-2018-0109314 (Patent document 0002) Korean Patent No. 10-0665350

### SUMMARY OF THE INVENTION

The invention addresses the above-identified and other problems associated with conventional methods and apparatuses, and provides a pressure regulator with fine control, which has a simple structure and prevents the pressure of a fluid from rotating a stem to thereby improve reliability of a product.

The invention also provides a pressure regulator which visually informs an patient whether a valve is currently opened or closed, thus allowing the patient to accurately move or shut off the fluid.

According to an embodiment of the invention, there is provided a pressure regulator with fine control, the pressure regulator including: a housing which has a housing space portion formed therein with a long shape in a longitudinal direction, and has an inlet port formed on one side thereof and communicating with the housing space portion in one direction and an outlet port formed on another side thereof and communicating with the housing space portion in another direction; a stem which is rotatably installed in the housing space portion, and has a stem inlet guide hole formed on one side thereof facing the inlet port, a stem outlet guide hole formed on another side thereof facing the outlet port, and a stem space portion formed therein and having an empty space so that the stem inlet guide hole and the stem outlet guide hole communicate with each other; and a rotation means configured to rotate the stem, wherein when the stem inlet guide hole is positioned to face the inlet port according to an angle at which the rotation means rotates the stem, a fluid flowing into the inlet port passes through the stem inlet guide hole and the stem space portion and flows out through the outlet port, wherein when the stem inlet guide hole is positioned not to face the inlet port, a fluid flowing into the inlet port is shut off so that the fluid is not guided to the stem inlet guide hole.

Also, the outlet port extends to communicate with one end, in the longitudinal direction, of the housing space portion, the rotation means is positioned at the other end, in the longitudinal direction, of the housing space portion and rotates the stem, and the stem outlet guide hole is provided at one end, in the longitudinal direction, of the stem that faces the one end, in the longitudinal direction, of the housing space portion.

Also, the pressure regulator further includes a tube configured to surround an outer circumference of the stem, wherein the tube has a tube inlet guide hole formed on one side thereof facing the inlet port and a tube outlet guide hole formed on another side thereof facing the outlet port, and an outer circumference of the tube and an inner circumference of the housing space portion are in water-tight contact with each other.

Also, the outlet port extends to communicate with one end, in the longitudinal direction, of the housing space portion, the rotation means is connected to the other end, in the longitudinal direction, of the housing space portion and rotates the stem, the stem outlet guide hole is provided at one end, in the longitudinal direction, of the stem that faces the one end, in the longitudinal direction, of the housing space portion, and the tube outlet guide hole is provided at one end of the tube that faces the stem outlet guide hole, wherein a pair of O-rings are respectively fitted on both sides of the tube, and the tube inlet guide hole is positioned between the pair of O-rings.

Also, the stem has a cylindrical shape, the stem space portion is formed inside the stem with a long shape and provided on a central axis of the stem, and the tube has a hollow cylindrical shape into which the stem is inserted.

Also, the pressure regulator further includes a position guide unit that is mounted between the rotation means and the housing, wherein a connection part is rotatably positioned inside the position guide unit, one end of the connection part is connected to the rotation means, the other end of the connection part is connected to the stem, and an indicator is formed on one side of an outer circumference between the one end and the other end of the connection part, and an exposure hole is formed on one side of the position guide unit so that the one side of the outer circumference of the connection part is exposed to the outside through the exposure hole, wherein when the indicator is exposed to the outside through the exposure hole as the connection part rotates along with the stem, the stem inlet guide hole is positioned to face the inlet port, wherein when the indicator is not exposed to the outside through the exposure hole, the stem inlet guide hole is positioned not to face the inlet port.

Also, the rotation means further includes a servomotor connected to the stem.

### Advantageous Effects

The pressure regulator with fine control according to the invention is configured to open the stem inlet guide hole with the simple structure of rotating the stem, and thus, the number of components may be reduced as much as possible. Accordingly, it is possible to improve the reliability of product and lower the manufacturing costs.

Also, the stem is positioned so as to be inserted into the housing space portion, and the central portion of the stem space portion, the stem inlet guide hole, and the inlet port are aligned with each other. Therefore, while the fluid flowing into the inlet port passes through the stem inlet guide hole and moves to the stem space portion, the fluid is guided to the central portion of the stem space portion, and the fluid does not apply pressure to the stem, so that the stem may be rotated with a small force. Accordingly, it is possible to finely adjust the rotation of the stem.

Also, the rotation of the stem may be finely adjusted, and the area of the stem inlet guide hole facing the inlet port may also be finely adjusted. Accordingly, it is possible to finely adjust the amounts of fluid that flows from the inlet port to the stem inlet guide hole.

In addition, depending on whether or not the indicator is exposed to the outside, it may be visually recognized from the outside whether the state of the stem inlet guide hole is currently opened or closed. Accordingly, it is possible to control the fluid to be accurately moved or shut off with respect to the patient.

Also, the stem and the tube are formed in a cylindrical shape and the stem space portion is formed lengthwise in the inner longitudinal direction of the stem, and thus, the stem and the tube are formed with a simple structure. Accordingly, it is possible to manufacture the components by low-cost injection molding.

Also, the tube and the housing space portion are in water-tight contact with each other, and thus, the fluid flowing into the inlet is not allowed to move to the outlet while the stem inlet guide hole is closed. Accordingly, it is possible to improve the reliability of the valve.

### BRIEF DESCRIPTION OF THE DRAWINGS

FIG. 1 is an exploded view of a pressure regulator with fine control according to an embodiment of the invention;

FIG. 2 is a view illustrating a housing space portion and an accommodation portion of the pressure regulator with fine control according to an embodiment of the invention;

FIG. 3 is a view illustrating a stem and a tube installed in the housing space portion of the pressure regulator with fine control according to an embodiment of the invention;

FIG. 4 is a view illustrating the cross-sections of the stem and the tube installed in the housing space portion of the pressure regulator with fine control according to an embodiment of the invention;

FIG. 5 is a view illustrating, as the cross-section, a state in which the pressure regulator with fine control according to an embodiment of the invention is opened;

FIG. 6 is a view illustrating that an indicator is not exposed to the outside in a state in which the pressure regulator with fine control according to an embodiment of the invention is closed;

FIG. 7 is a view illustrating, as the cross-section, a state in which the pressure regulator with fine control according to an embodiment of the invention is closed; and

FIGS. 8 and 9 are views for illustrating another example of a sub O-ring in a pressure regulator with fine control according to an embodiment of the invention.

### DETAILED DESCRIPTION OF THE EXEMPLARY EMBODIMENTS

The invention may be embodied in other various forms without departing from technical concepts or essential features. Therefore, embodiments of the invention are merely illustrative in all aspects and should not be construed as being limited.

Although the terms “first,” “second,” etc. may be used herein to describe various elements, these elements should not be limited by these terms.

These terms are only used to distinguish one element from another element. For example, a first element may be referred to as a second element, and similarly, a second element may also be referred to as a first element without departing from the scope of the invention.

It is understood that when an element is referred to as being “connected to” or “coupled to” another element, it can be directly connected or coupled to another element, or an intervening element may be present therebetween.

On the other hand, it is understood that when an element is referred to as being “directly connected to” or “directly coupled to” another element, there is no intervening element.

In the present application, the terms are used only to explain a specific embodiment and not intended to limit the invention. The singular forms include the plural forms as well, unless the context clearly indicates otherwise.

In the present application, it is understood that the term “includes,” “comprises,” or “have,” when used herein, specifies the presence of stated features, numbers, steps, operations, elements, components, or a combination thereof, but does not preclude the presence or addition of one or more other features, numbers, steps, operations, elements, components, or combinations thereof.

Unless otherwise defined, all terms used herein including technical or scientific terms have the same meanings as those generally understood by a person with ordinary skill in the art to which the invention pertains.

Terms as defined in a commonly used dictionary should be construed as having the same meaning as in an associated technical context, and unless defined apparently herein, are not to be understood abnormally or as having an excessively formal meaning.

Hereinafter, in order to describe the invention in detail to the extent that those skilled in the art can easily practice the invention, preferred embodiments of the invention are described in detail with reference to the accompanying drawings.

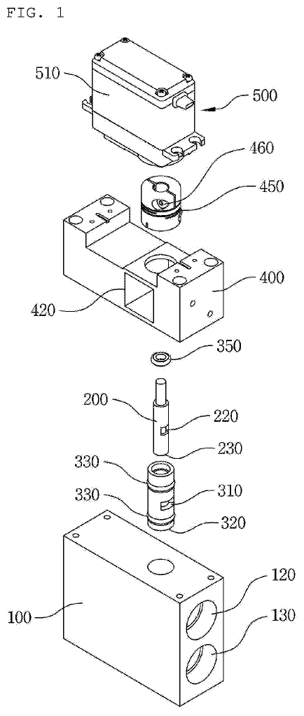

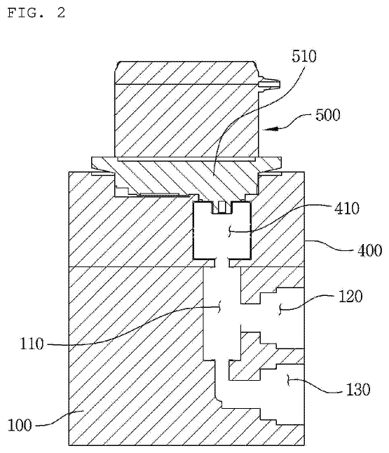

FIG. 1 is an exploded view of a pressure regulator with fine control according to an embodiment of the invention, and FIG. 2 is a view illustrating a housing space portion and an accommodation portion of the pressure regulator with fine control according to an embodiment of the Invention.

Referring to FIGS. 1 and 2, the pressure regulator with fine control includes a housing 100, a stem 200, a tube 300, a position guide unit 400, a connection part 450, and a rotation means 500.

The housing 100 is formed in a substantially hexahedral shape, and a housing space portion 110 is formed therein with a long shape in a longitudinal direction. The stem 200 and the tube 300 are positioned in the housing space portion 110. The stem 200 and the tube 300 are described below. In addition, an inlet port 120 is concavely formed on one side of the outer portion of the housing 100 so as to communicate with the housing space portion 110 in one direction, and an outlet port 130 is concavely formed on another side of the outer portion of the housing 100 so as to communicate with the housing space portion 110 in another direction.

The position guide unit 400 is mounted above the housing 100 and located between the rotation means 500 described below and the housing 100. An accommodation portion 410 having an empty space is provided inside the position guide unit 400, and an exposure hole 420 is formed through one side of the accommodating portion 410 so that the accommodation portion 410 is exposed to the outside. The lower side of the accommodation portion 410 is configured to communicate with the upper side of the housing space portion 110, and thus, the stem 200 located in the housing space portion 110 is connected to the connection part 450 located in the accommodation portion 410.

The connection part 450 is formed in, for example, a cylindrical shape and rotatably positioned in the accommodation portion 410 of the position guide unit 400. Also, the upper end of the connection part 450 is connected to the rotation means 500, and the lower end of the connection part 450 is connected to the stem 200. In addition, an indicator 460 is formed on one side of the outer circumference between the upper end and the lower end of the connection part 450. The indicator 460 is a mark that is easy to identify from the outside and may have, for example, an eye shape. In addition, the exposure hole 420 is formed on one side of the position guide unit 400 so that one side of the outer circumference of the connection part 450 is exposed to the outside. Therefore, according to the rotation angle of the connection part 450, the indicator 460 is exposed to the outside or not through the exposure hole 420.

The rotation means 500 includes a rotation body 510 and a motor (not shown). The rotation body 510 is mounted above the position guide unit 400. The motor is inserted into the rotation body 510 and may include a servomotor that may finely adjust the rotation angle. The motor is connected to the connection part 450 to rotate the connection part 450, and the connection part 450 rotates the stem 200.

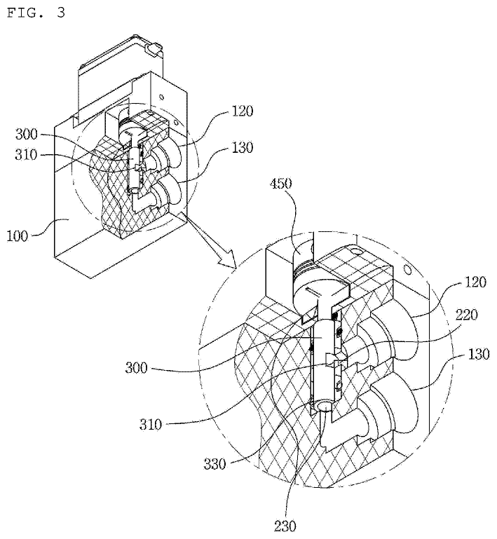

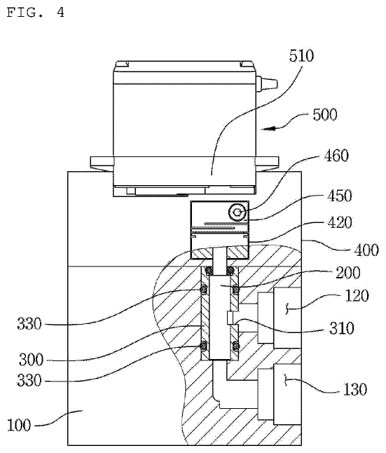

FIG. 3 is a view illustrating a stem and a tube installed in the housing space portion of the pressure regulator with fine control according to an embodiment of the invention, and FIG. 4 is a view illustrating the cross-sections of the stem and the tube installed in the housing space portion of the pressure regulator with fine control according to an embodiment of the invention.

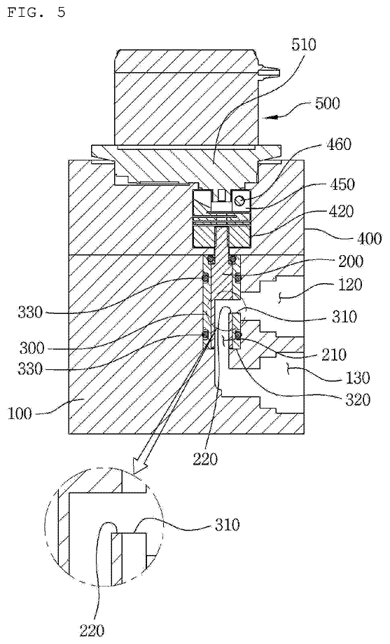

Referring to the diagram, the stem 200 has a cylindrical shape or the like and is rotatably installed in the housing space portion 110. In addition, a stem inlet guide hole 220 is formed on one side, facing the inlet port 120, of the stem 200, and a stem outlet guide hole 230 is formed on another side, facing the outlet port 130, of the stem 200. In addition, a stem space portion 210 having an empty space (shown in FIG. 5) is formed inside the stem 200 in the longitudinal direction such that the stem inlet guide hole 220 and the stem outlet guide hole 230 communicate with each other.

The upper end of the stem 200 is connected to the motor through the connection part 450, and the stem 200 is rotated by the rotational force of the motor. Here, the outlet port 130 extends to communicate with the lower end, in the longitudinal direction, of the housing space portion 110, the motor rotates the stem 200 while being positioned at the upper end, in the longitudinal direction, of the housing space portion 110, and the stem outlet guide hole 230 is formed at the lower end, in the longitudinal direction, of the stem 200 that faces the lower end, in the longitudinal direction, of the housing space portion 110. That is, the outlet port 130 and the stem outlet guide hole 230 are located at the lower end of the rotation axis of the stem 200, and thus, even when the stem 200 rotates, the positions of the outlet port 130 and the stem outlet guide hole 230 do not change.

Also, the stem inlet guide hole 220 is positioned perpendicular to the rotation axis of the stem 200, and thus, as the stem 200 rotates, the position of the stem inlet guide hole 220 is changed so as to face the inlet port 120 or not to face. When the position of the stem inlet guide hole 220 faces the inlet port 120, the stem inlet guide hole 220 is in an open state. On the other hand, when the position of the stem inlet guide hole 220 does not face the inlet port 120, the stem inlet guide hole 220 is in a closed state.

The tube 300 is formed to surround the outer circumference of the stem 200 and may have a hollow cylindrical shape so that the stem 200 is inserted therein. Also, a tube inlet guide hole 310 is formed on one side of the tube 300 that faces the inlet port 120, and a tube outlet guide hole 320 is formed on another side of the tube 300 that faces the outlet port 130. Also, the outer circumference of the tube 300 and the inner circumference of the housing space portion 110 may be in water-tight contact with each other. Accordingly, in a state in which the stem inlet guide hole 220 is closed, the fluid flowing into the inlet port 120 is not allowed to move to the outlet port 130, which improves the reliability of the valve.

Also, the stem 200 is configured to be easily rotatable inside the tube 300. To this end, the inner circumference of the tube 300 may be coated with a material for the outer circumference of the stem 200 to slide easily. Also, the tube 300 does not rotate when the stem 200 rotates, and thus, the stem inlet guide hole 220 is positioned to face the tube inlet guide hole 310 and the inlet port 120 or not to face, according to the rotation angle of the stem 200.

Accordingly, the stem 200 and the tube 300 have a cylindrical shape and the stem space portion 210 is formed in the longitudinal direction inside the stem 200, and thus, the stem 200 and the tube 300 have a simple structure. Therefore, the stem 200 and the tube 300 may be manufactured by low-cost injection molding.

In addition, a pair of O-rings 330 are respectively fitted on both sides of the tube 300, and the tube inlet guide hole 310 is positioned between the pair of O-rings 330. Accordingly, the pair of O-rings 330 are configured to water-tightly close the space between the tube 300 and the housing space portion 110, and thus, the fluid guided to the tube inlet guide hole 310 is not allowed to escape to another place through the space between the tube 300 and the housing space portion 110. Also, a sub O-ring 350 may be installed between the upper side of the tube 300 and the stem 200.

Hereinafter, the operation of the pressure regulator with fine control according to an embodiment of the invention is described.

FIG. 5 is a view illustrating, as the cross-section, a state in which the pressure regulator with fine control according to an embodiment of the invention is opened.

Referring to FIGS. 4 and 5, when the stem inlet guide hole 220 is positioned to face the tube inlet guide hole 310 and the inlet port 120 according to the angle at which the rotation means 500 rotates the stem 200, the stem inlet guide hole 220 is opened. Then, the fluid flowing into the inlet port 120 is allowed to flow in the stem space portion 210 through the tube inlet guide hole 310 and the stem inlet guide hole 220. Subsequently, the fluid flowing in the stem space portion 210 passes through the stem space portion 210 and flows out through the outlet port 130.

As described above, the invention is configured such that the stem inlet guide hole 220 is opened by the simple structure of rotating the stem 200, and thus, the number of components may be reduced as much as possible. Accordingly, it is possible to improve the reliability of product and lower the manufacturing costs.

Also, the stem 200 is positioned so as to be inserted into the housing space portion 110, and the central portion of the stem space portion 210, the stem inlet guide hole 220, and the inlet port 120 are aligned with each other. Therefore, while the fluid flowing into the inlet port 120 passes through the stem inlet guide hole 220 and moves to the stem space portion 210, the fluid is guided to the central portion of the stem space portion 210. That is, the fluid flowing from the inlet port 120 to the stem inlet guide hole 220 is guided toward the center of the stem space portion 210 without being biased to any one side. Therefore, the fluid does not apply pressure to rotate the stem 200 in any one direction, so that the stem 200 may be rotated with a small force, and thus, the stem 200 may be finely adjusted. Therefore, the rotation of the stem 200 may be finely adjusted, and the area of the stem inlet guide hole 220 facing the inlet port 120 may also be finely adjusted. Accordingly, it is possible to finely adjust the amounts of fluid that flows from the inlet port 120 to the stem inlet guide hole 220.

Also, when the stem inlet guide hole 220 is opened as the stem inlet guide hole 220 rotate to face the inlet port 120, the connection part 450 rotates along with the stem 200. Accordingly, the indicator 460 provided on the connection part 450 is exposed to the outside through the exposure hole 420. As described above, a user may visually check the position of the indicator 460 formed on the connection part 450 through the exposure hole 420, and thus, it is possible to visually and clearly identify whether the stem inlet guide hole 220 is currently opened or closed. Therefore, it may be visually recognized from the outside whether the state of the stem inlet guide hole 220 is currently opened or closed. Accordingly, it is possible to control the fluid to be accurately moved or shut off with respect to the patient.

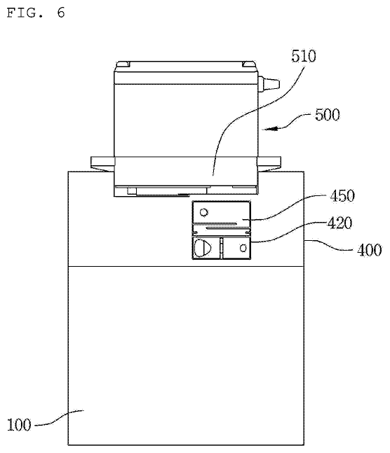

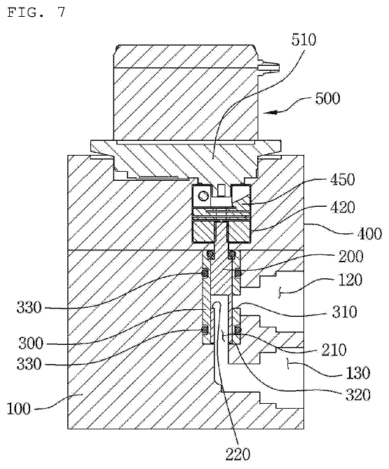

FIG. 6 is a view illustrating that an indicator is not exposed to the outside in a state in which the pressure regulator with fine control according to an embodiment of the invention is closed, and FIG. 7 is a view illustrating, as the cross-section, a state in which the pressure regulator with fine control according to an embodiment of the invention is closed.

Referring to FIGS. 6 and 7, when the stem inlet guide hole 220 is positioned not to face the inlet port 120 as the rotation means 500 rotates the stem 200, the stem inlet guide hole 220 is closed. Then, the fluid flowing into the inlet port 120 is blocked so as not to be guided to the stem inlet guide hole 220.

On the other hand, when the stem inlet guide hole 220 is closed, the indicator 460 is positioned to face the opposite side of the exposure hole 420. Accordingly, the indicator 460 is not exposed to the outside through the exposure hole 420. Therefore, the user may visually accurately recognize that the stem inlet guide hole 220 is positioned so as not to face the inlet port 120, that is, the stem inlet guide hole 220 is in a closed state.

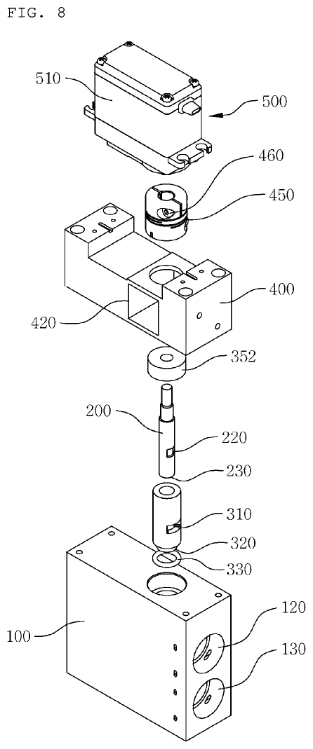

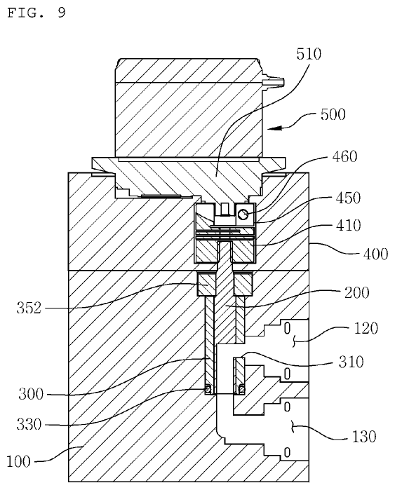

FIGS. 8 and 9 are views for illustrating another example of a sub O-ring in a pressure regulator with fine control according to an embodiment of the invention.

Referring to FIGS. 8 and 9, a sub O-ring 352 may be installed above a tube 300 to surround an upper outer circumference of a stem 200 that protrudes upward from the tube 300. The diameter of the sub O-ring 352 is greater than the diameter of the tube 300, and thus, the lower side of the sub O-ring 352 is in water-tight contact with the upper side of the tube 300. Accordingly, the fluid moving around the tube 300 and the fluid moving upward from the stem 200 are blocked by the sub O-ring 352 and thus may not move toward a connection part 450.

It is appreciated that the invention is not limited to the forms mentioned above in the detailed description. Therefore, the real protective scope of the invention is determined by the technical ideas of the appended claims. Also, it is to be understood that the invention includes all modifications, equivalents, and alternatives within the spirit and scope of the invention as defined by the appended claims.

What is claimed is:

1. A pressure regulator with fine control, comprising:
a housing which has a housing space portion formed therein with a long shape in a longitudinal direction, and has an inlet port formed on one side thereof and communicating with the housing space portion in one direction and an outlet port formed on another side thereof and communicating with the housing space portion in another direction;
a stem which is rotatably installed in the housing space portion, and has a stem inlet guide hole formed on one side thereof facing the inlet port, a stem outlet guide hole formed on another side thereof facing the outlet port, and a stem space portion formed therein and having an empty space so that the stem inlet guide hole and the stem outlet guide hole communicate with each other; and
a rotation means configured to rotate the stem,
wherein when the stem inlet guide hole is positioned to face the inlet port according to an angle at which the rotation means rotates the stem, a fluid flowing into the inlet port passes through the stem inlet guide hole and the stem space portion and flows out through the outlet port,
wherein when the stem inlet guide hole is positioned not to face the inlet port, a fluid flowing into the inlet port is shut off so that the fluid is not guided to the stem inlet guide hole.

2. The pressure regulator according to claim 1,
wherein the outlet port extends to communicate with one end, in the longitudinal direction, of the housing space portion, the rotation means is positioned at the other end, in the longitudinal direction, of the housing space portion and rotates the stem, and
the stem outlet guide hole is provided at one end, in the longitudinal direction, of the stem that faces the one end, in the longitudinal direction, of the housing space portion.

3. The pressure regulator according to claim 1,
further comprising a tube configured to surround an outer circumference of the stem,
wherein the tube has a tube inlet guide hole formed on one side thereof facing the inlet port and a tube outlet guide hole formed on another side thereof facing the outlet port, and
an outer circumference of the tube and an inner circumference of the housing space portion are in water-tight contact with each other.

4. The pressure regulator according to claim 3,
wherein the outlet port extends to communicate with one end, in the longitudinal direction, of the housing space portion,
the rotation means is connected to the other end, in the longitudinal direction, of the housing space portion and rotates the stem,
the stem outlet guide hole is provided at one end, in the longitudinal direction, of the stem that faces the one end, in the longitudinal direction, of the housing space portion, and
the tube outlet guide hole is provided at one end of the tube that faces the stem outlet guide hole,
wherein a pair of O-rings are respectively fitted on both sides of the tube, and the tube inlet guide hole is positioned between the pair of O-rings.

5. The pressure regulator according to claim 3,
wherein the stem has a cylindrical shape,
the stem space portion is formed inside the stem with a long shape and provided on a central axis of the stem, and
the tube has a hollow cylindrical shape into which the stem is inserted.

6. The pressure regulator according to claim 1,
further comprising a position guide unit that is mounted between the rotation means and the housing,
wherein a connection part is rotatably positioned inside the position guide unit,
one end of the connection part is connected to the rotation means, the other end of the connection part is connected to the stem, and an indicator is formed on one side of an outer circumference between the one end and the other end of the connection part, and
an exposure hole is formed on one side of the position guide unit so that the one side of the outer circumference of the connection part is exposed to the outside through the exposure hole,
wherein when the indicator is exposed to the outside through the exposure hole as the connection part rotates along with the stem, the stem inlet guide hole is positioned to face the inlet port,
wherein when the indicator is not exposed to the outside through the exposure hole, the stem inlet guide hole is positioned not to face the inlet port.

7. The pressure regulator according to claim 1,
wherein the rotation means further comprises a servomotor connected to the stem.
